(19) United States
(12) Patent Application Publication
(10) Pub. No.: US 2016/0009386 A1
(43) Pub. Date: Jan. 14, 2016

(54) LOW MOMENT FORCE GENERATOR DEVICES AND METHODS

(71) Applicant: LORD CORPORATION, Cary, NC (US)

(72) Inventors: Michael W. TRULL, Apex, NC (US); Michael D. JANOWSKI, Clayton, NC (US); Jihan RYU, Seoul (KR); Reuben SCHUFF, Raleigh, NC (US); John Mark FREEZE, Raleigh, NC (US)

(73) Assignee: LORD CORPORATION, Cary, NC (US)

(21) Appl. No.: 14/773,029

(22) PCT Filed: Mar. 20, 2014
(86) PCT No.: PCT/US2014/031310

§ 371 Date: Sep. 4, 2015

Related U.S. Application Data
(60) Provisional application No. 61/803,623, filed on Mar. 20, 2013.

(51) Int. Cl. B64C 27/00; F16F 15/22

(52) U.S. Cl. CPC B64C 27/001; F16F 15/223

(57) ABSTRACT

Improved force generator (FG) devices and methods are provided herein. A FG device (10) includes a housing (16, 18), a shaft (S) centrally disposed within the housing, and multiple imbalance rotors (30, 32, 34, 36, 38) disposed within the housing and provided along the shaft. At least two pairs (PA, PB) of imbalance rotors are provided in a nested configuration with respect to each other along the shaft. The at least two pairs (PA, PB) of imbalance rotors are supported in the nested configuration by large and small bearings (BA, BB). Any two imbalance rotors are paired to rotate together in a same direction according to a desired vibration canceling force. A method of controlling vibration within a structure is provided. The method includes detecting vibration, receiving a force command at a FG device, and pairing any two imbalance masses together and rotating a pair of imbalance masses via the rotors together in a same direction to cancel the detected vibration.

### CROSS REFERENCE TO RELATED APPLICATION

This application relates to and claims priority to U.S. Provisional Patent Application Ser. Nos. 61/803,623, filed on Mar. 20, 2013, the disclosure of which is fully incorporated herein by reference, in the entirety.

### TECHNICAL FIELD

The present subject matter relates generally to vibration control, and devices and methods associated with cancelling vibrations in a structure. More particularly, the present subject matter relates a force generator (FG) devices and related methods for providing omnidirectional vibration control within a structure.

### BACKGROUND

Various structures (e.g., vehicles, aircraft, buildings, etc.) are subjected to one or more vibration forces due to mechanical or naturally occurring external forces. The vibrations are communicated in one or more directions, and are caused by components positioned on or in the structure, or by an environmental condition imparting a vibration force to the structure. The vibrations are further exacerbated at key points within a structure, such as a bearing.

For example, in rotary wing aircraft, such as helicopters, vibrations transmitted by large rotors can contribute to fatigue and wear on equipment, materials, and occupants within the aircraft. Vibrations can damage the actual structure and components of the aircraft, such as bearings, as well as contents disposed within the aircraft. This increases costs associated with maintaining and providing rotary winged aircraft, such as costs associated with inspecting and replacing parts within the aircraft, which may become damaged by vibration.

Current force generator (FG) designs fail to minimize reaction moments (e.g., roll/yaw moments) on the vibrating structure. Current force generator (FG) designs also exhibit cantilevered bearing loads, in some aspects, because of an offset or un-aligned force plane. Cantilevered loads can overload one or more pairs of bearings within conventional FG designs, thereby decreasing the usable life of bearings and/or the FG.

Accordingly, there is a need for improved low moment FGs and related methods for controlling vibrations in a structure, in some aspects, which can extend bearing life and, therefore, the FG life, by about 20× or more.

### SUMMARY

In accordance with the disclosure provided herein, novel and improved force generators (FGs) and related methods are provided. A FG device includes a housing, a shaft centrally disposed within the housing, and at least two inner imbalance masses provided in a side-by-side configuration within the housing along the center shaft. The inner imbalance masses are each supported by a large bearing movably coupled with the center shaft. At least two outer imbalance masses are oppositely positioned from each along the center shaft with one outer imbalance mass positioned outwardly from one of the inner imbalance masses and the other outer imbalance mass positioned outwardly from the other inner imbalance mass such that each inner imbalance mass is paired with the outer imbalance mass, thereby forming a pair. The outer imbalance masses each have a small bearing movably disposed about the center shaft. The pairs of imbalance masses rotate about the center shaft to minimize moments imparted to vibrating structure.

A FG device also includes a housing, a shaft centrally disposed within the housing, and multiple imbalance rotors disposed within the housing and provided along the shaft. At least two pairs of imbalance rotors are provided in a nested configuration with respect to each other along the shaft. The at least two pairs of imbalance rotors are supported in the nested configuration by large and small bearings. Any two imbalance rotors are paired to rotate together in a same direction according to a desired vibration canceling force.

A method of controlling vibration within an aircraft is provided. The method includes detecting vibration within the aircraft, receiving a force command at a FG device, and pairing any two imbalance masses together and rotating a pair of imbalance masses via the rotors together in a same direction to cancel the detected vibration. The FG device includes a housing, a shaft centrally disposed within the housing, and multiple imbalance rotors disposed within the housing and provided along the shaft. At least two pairs of imbalance rotors are provided in a nested configuration with respect to each other along the shaft. The at least two pairs of imbalance rotors are supported by large and small bearings.

### BRIEF DESCRIPTION OF THE DRAWINGS

FIG. 1 illustrates a perspective view of a force generator (FG).

FIG. 2 illustrates a front sectional view according to a first embodiment of the FG illustrated in FIG. 1.

FIGS. 3A-B graphically illustrate moment limit plots for CFG pairing of the imbalance rotors and respective imbalance masses for the first embodiment illustrated in FIG. 2.

FIGS. 4A-B graphically illustrate moment limit plots for inner/outer pairing of the imbalance rotors and respective imbalance masses for the first embodiment of the FG illustrated in FIG. 2.

FIG. 5 illustrates a front sectional view according to a second embodiment of the FG illustrated in FIG. 1.

FIGS. 6A-B graphically illustrate the normal operation of the embodiment of the FG illustrated in FIG. 5.

FIGS. 7A-B graphically illustrate a failure mode when one (1) rotor/side reverses direction and pairing becomes inner/outer.

FIG. 8 illustrates a method of checking spin direction according to aspects of the subject matter herein.

### DETAILED DESCRIPTION

Numerous objects and advantages of the present subject matter become apparent as the following detailed description of the preferred embodiments is read in conjunction with the drawings, which illustrate such embodiments.

Reference is made in detail to possible aspects or embodiments of the subject matter herein, one or more examples of which are shown in the accompanying drawings. Each example is provided to explain the subject matter and not a limitation. In fact, features illustrated or described as part of one embodiment may be used in another embodiment to yield still a further embodiment. It is intended that the subject matter described, disclosed, and envisioned herein covers such modifications and variations. It is understood that any vehicle or structure that is subjected to multiple vibrations may benefit from devices and methods provided herein.

As used herein, the term “nested” refers to components having a nested fit or a nested configuration, where one component is at least partially enclosed within and/or closer to a shaft of a rotating device with respect to another component. In some aspects, FG devices may have nested imbalance masses, nested imbalance rotors, nested bearings, and/or combinations thereof. Side-by-side configurations (e.g., of imbalance rotors, bearings, and/or imbalance masses) may be used in addition to nested configurations.

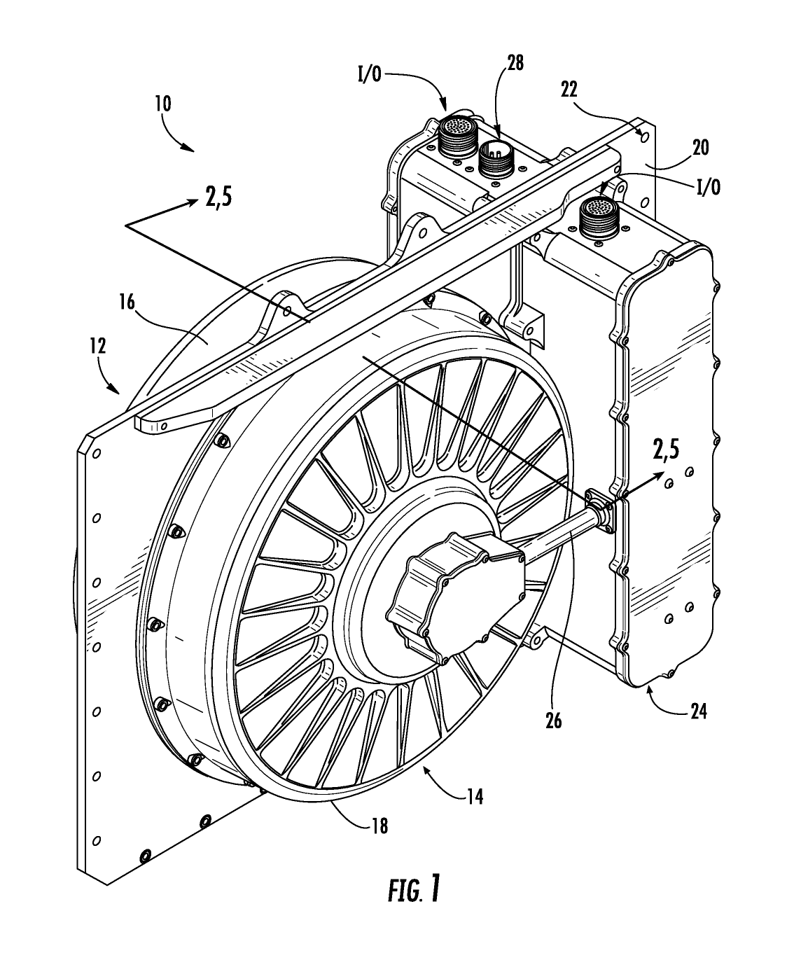

FIGS. 1 to 8 illustrate various aspects and/or features associated with force generator (FG) devices and related methods associated with controlling vibration within an aircraft, namely, within a rotary wing aircraft. In some aspects, FG devices and related methods described herein are adapted for use in single rotor and/or a tandem rotor aircraft. FG devices described herein include omnidirectional actuators, which are configured to exert or generate bi-directional forces to vibration portions of the aircraft, and control vibrations via the exerted and/or generated forces. FG devices described herein are configured generate and/or exert forces in response to receiving a force command from one or more controllers provided on and/or within the vibration structure. The lifetime of conventional FG devices is limited by the bearings, which typically have a mean time between failures (MTBF) of about 2500 hours. Conventional bearings react unbalanced cantilevered loads, which are offset and/or overloaded on one side, which leads to decreased bearing life.

FG devices and methods described herein have a substantially increased lifetime, as the MTBF increases to over 50,000 hours (e.g., greater than a factor of 20) or more. In some aspects, this is accomplished by balancing the loads reacted within FG devices, for example, by nesting rotors, bearings, masses, and/or components thereof for improved load sharing. This is also accomplished by aligning the force plane at a center of the bearings (e.g., inner and outer) of bearings, such that loads associated with imbalance masses housed within a FG device are reacted by more than one bearing. In some aspects, reaction moments imparted to vibration structures described herein are also minimized.

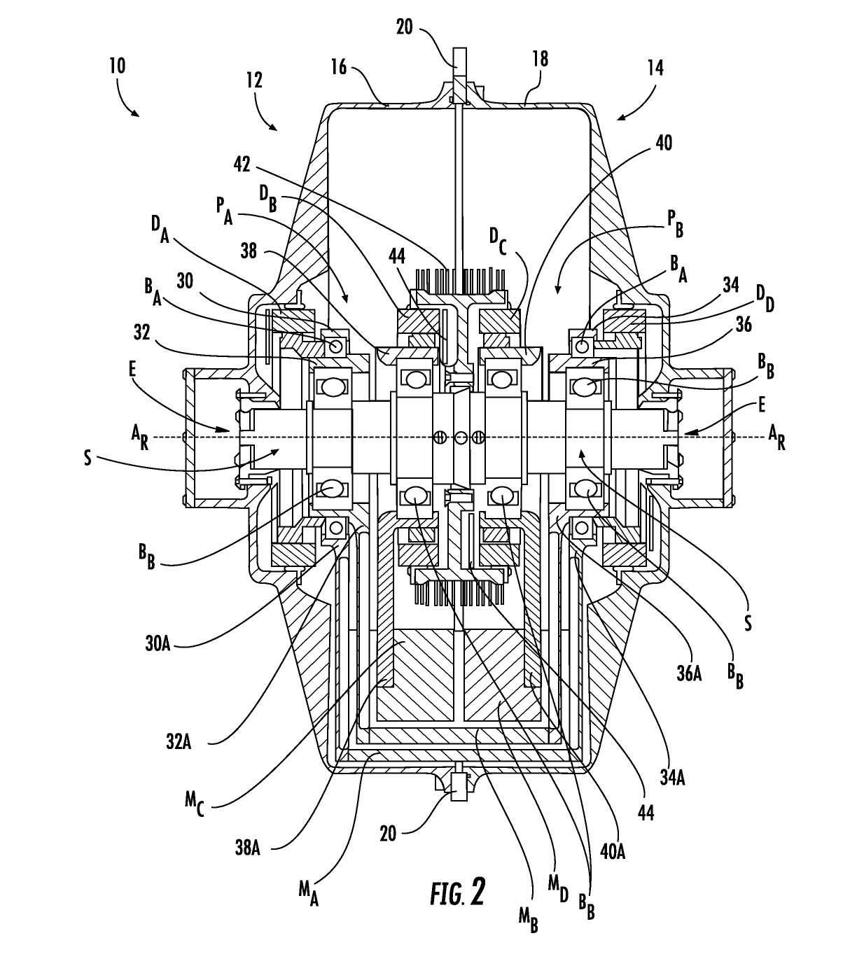

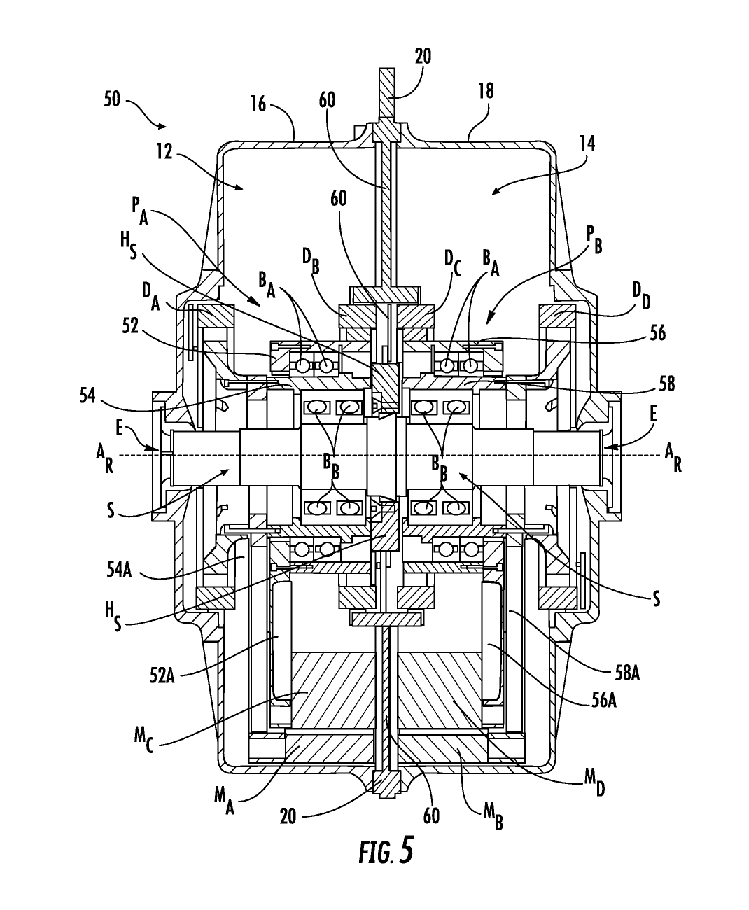

FIGS. 1 and 2 are perspective and sectional views of a FG device, generally designated 10 for use in an active vibration control system (not shown). In some aspects, FG device 10 includes multiple back-to-back circular force generators (CFGs) integrated within a housing. The phasing and magnitude at which each CFG operates is controlled (e.g., via force commands issued from a controller) to generate a desired force, such as a bi-direction (e.g., cyclic) and/or linear (e.g,. vertical/horizontal) force. In some aspects, device 10 includes a first CFG 12 disposed adjacent to a second CFG 14. As described hereinbelow, FG devices described herein include at least two imbalance masses (i.e., one pair of masses, FIGS. 2, 5), which may be paired differently (e.g., inner/inner, inner/outer and outer/outer) for generation of different vibration cancelling forces. This is also known as CFG pairing. In some aspects, CFG pairing includes pairing masses within each of the respective first and second CFGs 12 and 14, such that the masses within each respective CFG rotate in a same direction. When CFGs are paired, the pair of masses in first CFG 12 rotate in a same direction, which is opposite from the pair of masses in second CFG 14 for creating a desired vibration cancelling force.

In some aspects, first CFG 12 is at least partially disposed within a first housing 16. Second CFG 14 is at least partially disposed within a second housing 18. In some aspects, a mounting plate 20 is disposed between portions of first and second housings 16 and 18, respectively. First and second housings 16 and 18, respectively, may be secured to portions of mounting plate 20 via mechanical fasteners, such as screws. Housings 16, 18, and/or mounting plate 20 may each include a metallic material, such aluminum (Al), steel, and/or alloys thereof.

Mounting plate includes a plurality of apertures 22 provided and adapted to receive mechanical fasteners thereby securing device 10 to portions of a rotary winged aircraft frame and/or rotors of the aircraft (not shown). Mechanical fastening devices may include, for example, screws, bolts, nails, rivets, pins, clips, hooks, etc. and are not limited to a particular type or configuration. Apertures 22 are provided over multiple surfaces or edges of device 10, for example, both horizontal and vertical edges of device 10, such that device 10 is attachable in multiple different configurations with respect to the aircraft, as desired. That is, device 10 is not limited to horizontal or vertical mounting, and may be mounted in various different configurations within an aircraft.

Device 10 further includes an electronics enclosure or electronics housing, generally designated 24. One or more conduits 26 provide electrical communication between electronic devices housed within electronics enclosure 24 and portions of the nested CFGs within device 10. Electronics enclosure 24 includes input and output channels designated I/O, for communicating with a controller (not shown) that is disposed onboard the aircraft. The controller instructs or commands device 10 to generate forces for controlling vibration of the aircraft and/or portions thereof in response to inputs such as information received from one or more sensors (e.g., vibration detected via tachometers or accelerometers), manual inputs (e.g., via a pilot switch), flight condition, etc. Electronics enclosure 24 further includes a power interface 28. Power interface 28 is configured to receive electrical signal, current, and/or electrical power directly from the rotary winged aircraft, or from a generator (not shown).

Electronics enclosure 24 includes computer hardware including one or more processors and a memory (not shown). Enclosure 24 may include multiple processors as shown and described (i.e., in FIGS. 1, 34A and 34B, and in the corresponding text) in commonly owned, assigned, and co-p-ending Patent Application No. PCT/US13/71452, filed on Nov. 22, 2013, the disclosure of which is fully incorporated herein by reference, in the entirety. Processor(s) within enclosure 24 may be configured to control rotation speed, rotation frequency, and/or other aspects of CFGs 12 and 14. Processor(s) may also control an amount of power transmitted to drive motors (e.g., D_{A}, D_{B}, D_{C}, and D_{D}) of device 10. In some aspects, software is implemented via a non-transitory computer readable medium having stored thereon computer executable instructions that when executed by processor(s) housed within enclosure 24 allow device 10 to generate vibration canceling forces via CFGs 12 and 14 in response to one or more force commands communicated from a controller. The forces generated by one or more devices 10 within an aircraft actively cancel and/or control the omnidirectional and complex vibration occurring within the aircraft due to the rotating blades and/or rotors of the aircraft.

Device 10 is configured to generate bi-directional forces for cancelling or significantly reducing vibration within a rotary winged aircraft and/or any other vibrating structure. In some aspects, the bi-directional force may be limited to one direction, where desired. Any bi-directional force may be provided via the dual CFG design. when rotors and respective masses of first and second CFGs 12 and 14, respectively, are spun in opposite directions.

Referring now to FIG. 2, internal structures associated FG device 10 are illustrated. FG includes a plurality of rotors, with at least two rotors being nested relative to at least two other rotors. Nesting rotors allows forces to be counteracted, or reacted, by the corresponding by more than one bearing, such as two to four bearings. This action results in significantly lower bearing loads when compared to traditional cantilevered rotors used in the industry. The improvement provides for at least a factor of 20× improvement in the bearing life of the FG device 10.

In some aspects, each CFG 12 and 14 of device includes at least one pair of nested imbalance rotors, generally designated P_{A} and P_{B}. Each pair of nested rotors P_{A} and P_{B} is disposed on outermost ends of a shaft S, to minimize moments imparted upon the vibrating structure, such as an aircraft structure. This allows bearing loads to remain low, and increases the MTBF of bearings to approximately 50,000 hours or more, approximately 60,000 hours or more, or more than 80,000 hours. The nested rotors and nested bearings are adapted to split and/or divide the loads uniformly between with inner bearings, which eliminates cantilever bearing loads in which bearings are non-uniformly loaded.

First CFG 12 includes a first pair of imbalance rotors P_{A}. Second CFG 14 includes a second pair of imbalance rotors P_{B}. First pair of imbalance rotors P_{A} of first CFG 12 includes a first imbalance rotor 30 disposed at least partially about a second imbalance rotor 32. Similarly, a second pair of imbalance rotors P_{B} of second CFG 14 includes a first imbalance rotor 34 disposed at least partially about a second, inner imbalance rotor 36. That is, first imbalance rotors 30 and 34 are further away from a central shaft S than second imbalance rotors 32 and 36. Each pair of nested rotors P_{A} and P_{B} associated with CFGs 12 and 14 are provided adjacent to (e.g., side-by-side) at least one additional, inner rotor. The pair of nested rotors P_{A} and P_{B} thus splits loads with at least one other rotor/bearing assembly. For example, first pair P_{A} of nested rotors (i.e., comprised of 30 and 32) is provided adjacent to at least one other rotor 38. In some aspects, first pair P_{A} of nested rotors is collectively deemed an “outer” rotor as it is disposed along outermost portions (e.g., proximate edges E) of shaft S, and the other rotor 38 is deemed an “inner” rotor. First pair P_{A} of nested rotors may uniformly split the load with inner rotor 38, which eliminates either the inner or the outer bearings from becoming overloaded. Similarly, second pair P_{B} of nested rotors (i.e., comprised of 34 and 36) is provided along outer portions of shaft S, adjacent to at least one other inner rotor 40. Second pair P_{B} of outer nested rotors (e.g., deemed an outer rotor) may uniformly split the force load (e.g., radial load on the bearing) with inner rotor 40. Four rotors (e.g., a first outer rotor including 30/34, a second outer rotor including 32/36, a third inner rotor including 38, and a fourth inner rotor including 40), respective rotor frames, and imbalance masses are provided per device 10. Two rotors, respective frames, and masses are provided in one CFG and one housing 16 and two other rotors, frames, and masses are provide in the other CFG and other 18. Rotors 38 and 40 are more centrally disposed with respect to device 10, hence are deemed “inner” rotors. Nested rotors (e.g., 30/34, 32/36) are collectively deemed “outer” rotors, as each are disposed on the outermost portions of shaft S with respect to inner rotors 38 and 40.

Each pair of nested rotors P_{A} and P_{B} also include nested bearings. First rotors 30 and 34 include small bearings B_{A}. Second rotors 32 and 36 include a second type and/or size of bearing B_{B}, which is nested between rotor 32 and small bearing B_{A}. Second type of bearings B_{B} is larger in size (e.g., diameter) than the smaller, outermost bearings B_{A}. Second type of bearings B_{B} are nested within first bearings B_{A}. Third rotors 38 and 40 also include bearings B_{B}, which are larger in size than small bearings (e.g., B_{A} of the nested rotor/bearing assemblies). Larger bearings B_{B} are directly coupled to shaft S, which reduces bearing loads and improves the MTBF associated with bearings B_{B}.

Nesting rotors and bearings aligns the force plane more evenly at a center of the bearings, such that the bearing pair (B_{A}/B_{B}) and inner bearings B_{B} associated with inner rotors 38 and 40 more uniformly split force loads, and more than one bearing reacts loads proximate the outermost portions or ends E of shaft S. This serves to reduce, minimize, and/or eliminate cantilever bearing loads, and extend bearing life. The nested rotors incorporate smaller bearings B_{A}. At outermost portions of shaft S, the smaller bearings B_{A} are able to react one-half (½) of the force loading from the outer rotors while the larger, nested inner bearings B_{B} (e.g., between rotor 32 and small bearing B_{A}) are able to react force loading from both of the nested outer rotors. Device 10 has a low reaction moment limit for any potential rotor configuration for any given commanded force magnitude/phase. Improved load sharing also provides for greater reliability with the MTBF of the rotor bearings being greater than approximately 50,000 hours and/or greater than approximately 60,000 hours. This 20× improvement in MTBF is a direct result of the low bearing loads from the nested rotors (e.g., pairs P_{A} and P_{B}).

As discussed hereinbelow and illustrated in FIG. 2, load from imbalance mass M_{C} is reacted by the single inner bearing B_{B}, and the load from imbalance mass M_{D} is reacted by the single inner bearing B_{B}. Smaller bearings B_{A} react the load from first outer imbalance mass M_{A} and nested inner bearings B_{B} react the load from first outer imbalance mass M_{A} in combination with second outer imbalance mass M_{B}, also represented as M_{A}+M_{B}.

Each rotor (e.g., 30/32, 34/36, 38, and 40) has a respective rotor frame (e.g., 30A/32A, 34A/36A, 38A, and 40A) by which one or more imbalance masses rotate about shaft S. Any one pair of rotors and imbalance masses may be paired to rotate in a same, first direction. The other pair may rotate in a same direction, that is opposite from the first direction. Rotors, bearings, and imbalance masses rotate about and/or with respect to a rotation axis A_{R} of shaft S. Opposing ends of shaft S, generally designated E, are also fixedly held within device 10. Rotation axis A_{R} is a centrally disposed with respect to device 10. Rotors, bearings, and imbalance masses each include side-by-side and nested components with respect to shaft S.

In some aspects, one pair of rotors (e.g., 30/32, 34/36, 38, and 40) rotates about shaft S in a direction, a magnitude, and/or a phase communicated via controller (not shown). One pair of nested rotors P_{A} is at least partially connected to and/or configured to support a first outer imbalance mass M_{A}. The other pair of nested rotors P_{B} is at least partially connected to and/or configured to support a second, outer imbalance mass M_{B}. Innermost rotors 38 and 40, which are disposed side-by-side to at least one pair of nested rotors, are at least partially connected to and/or configured to support third and fourth imbalance masses M_{C} and M_{D}, respectively, which are side-by-side inner imbalance masses.

In some aspects, rotors (e.g., 30/32, 34/36, 38, and 40) are adapted to rotate the imbalance masses M_{A} to M_{D} about portions of shaft S. Rotors (e.g., 30/32, 34/36, 38, and 40) are supported on shaft S via bearings B_{B}. In some aspects, device 10 includes at least four rotors (i.e., two nested, P_{A}, P_{B} and two side-by-side, 38, 40) configured to rotate at least four respective imbalance masses M_{A} to M_{D} about shaft S. The resultant forces from rotation of imbalance masses M_{A} to M_{D} about shaft S is bi-directional and optimally linear, has low reaction moments, and is configured to counteract and/or eliminate vibration occurring within a structure, such as an aircraft. The speed, frequency, magnitude, and/or phase at which imbalance masses M_{A} to M_{D} rotate about shaft S is controlled via a controller (not shown) in response to force commands or signals. Any two of the four imbalance masses M_{A} to M_{D} may be paired to spin in a same direction for creating the net bi-directional and/or linear forces.

Still referring to FIG. 2, device 10 also includes a non-rotating portion, such as a stator support 42. Stator support 42 includes a support structure for retaining stators of inner motors of device 10, rotors 32 to 40, and first through fourth imbalance masses M_{A} to M_{D}. In some aspects, one pair of nested rotors P_{A} and/or P_{B} and at least one additional rotor 38 and 40, are disposed on opposing sides of stator support 42.

Device 10 further includes multiple drive motors, generally designated D_{A} to D_{D}. At least four drive motors D_{A} to D_{D} are disposed side-by-side for rotating the pair of nested and side-by-side rotors. In some aspects, a first drive motor D_{A} is configured to supply power to and rotate first pair of nested rotors P_{A} within first CFG 12. A second motor D_{B} supplies power to and/or rotates inner rotor 38 of CFG 12, which is adjacent to and/or side-by-side in respect to the first pair of nested rotors P_{A}. A third motor D_{C} supplies power to and/or rotates rotor 40 of second CFG 14, which is adjacent to a second pair of nested rotors P_{A}. A fourth motor D_{D} supplies power to and/or rotates second pair of nested rotors P_{B} of second CFG 14. In some aspects, first through fourth motors D_{A} to D_{D}, respectively, include brushless DC motors. Each motor receives electrical current or power from portions of the aircraft via conduits 26 (FIG. 1) which transmit electrical power received at enclosure 24 (FIG. 1).

As FIG. 2 further illustrates, first and second imbalance masses M_{A} and M_{B} are nested, or in a nested configuration about shaft S. That is, first imbalance mass M_{A} is disposed about portions of second imbalance mass M_{B}, without physically touching second imbalance mass M_{B}. In some aspects, second imbalance mass M_{B} is closer in distance to shaft S than first imbalance mass M_{A}. Second and third (i.e., side-by-side, inner) imbalance masses M_{C} and M_{D}, respectively, are side-by-side, or in a side-by-side configuration within device 10. Each imbalance mass is physically distinct or separated from each other imbalance mass. In some aspects, the pair of nested imbalance masses (e.g., M_{A}, M_{B}) are disposed about portions of the side-by-side imbalance masses (e.g., M_{C}, M_{D}).

Device 10 is configured to rotate one pair of imbalance masses (e.g., M_{A} to M_{D}) in one direction and another pair of imbalance masses in another direction. For example, two side-by-side inner masses M_{C} and M_{D} may rotate together, and by virtue of this pairing, at the same time the two nested masses M_{A} and M_{B} also rotate together. In other aspects, both masses within CFG 12 may be paired (i.e., deemed “inner/outer”) and may rotate together in a first direction. When CFGs are paired, masses within second CFG 14 rotate together in an opposite direction from the first direction. In some aspects, the side-by-side masses (e.g., M_{C} and M_{D}) and the nested masses (M_{A} and M_{B}) are paired according to desired reaction moments. Different rotors and imbalance masses may be paired, for example, inner rotors (e.g., 38, 40) may be paired (i.e., “inner/inner” pairing) for rotating side-by-side third and fourth imbalance masses M_{C} and M_{D} together and in a same direction. During inner pairing, outer rotors (e.g., pairs P_{A} and P_{B}) are also paired (i.e., “outer/outer” pairing) for rotating first and second nested imbalance masses M_{A} and M_{B} together and in a same direction. The phase and magnitude at which masses rotate may be controlled via a controller and/or specified by a force command from a controller.

Device 10 further includes at least one Hall sensor 44 disposed proximate a centerline shaft S. More than one Hall sensor 44 may be provided per device, and at different locations in device 10. Hall sensor 44 is configured to provide position control of rotors and/or imbalance masses within device 10. Hall sensor 44 obviates the need for a rotary encoder for providing position control and implements position control via keying the mechanical components within device 10, which allow software parameters executed by one or more processors of device 10 to be hard-coded. Accordingly, device 10 is encoderless.

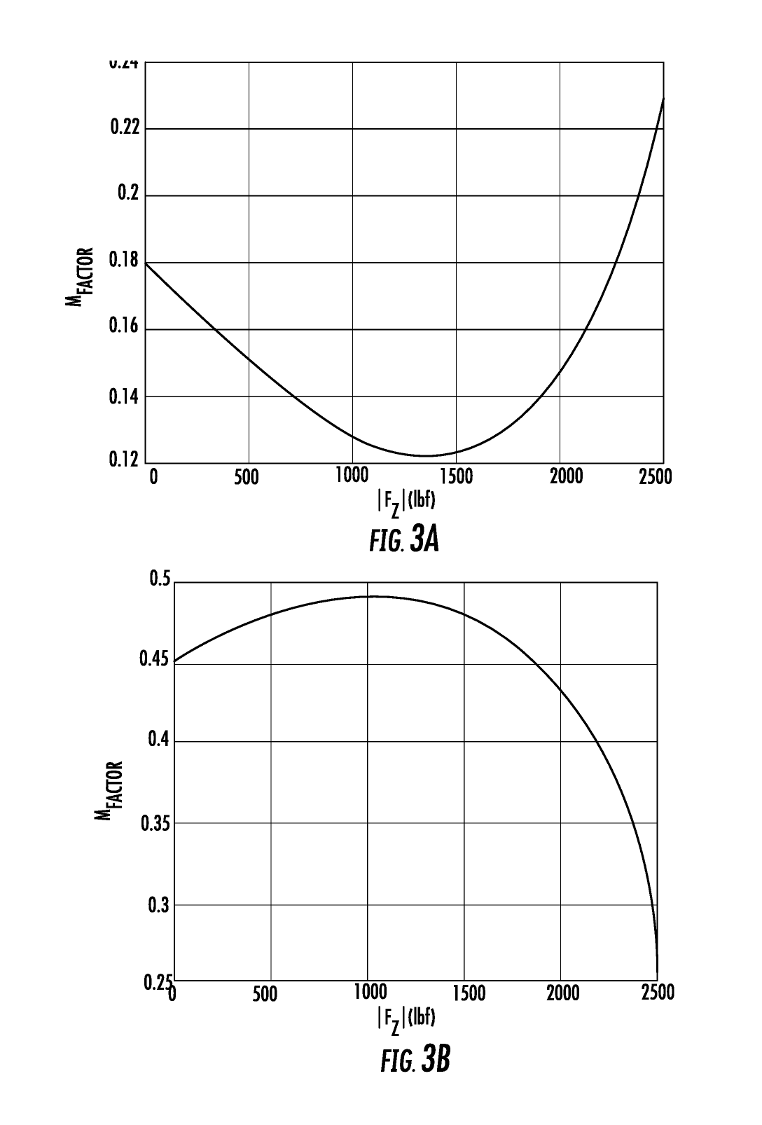

FIGS. 3A and 3B are moment limit plots illustrating the reduced reaction moments within device 10. Each plot is for different rotor pairing options. FIGS. 3A and 3B are moment limit plots illustrative of CFG pairing, where both masses (e.g., one inner and one outer) within each CFG are spinning in a same direction, and where masses within different CFGs spin in opposite directions. By lowering the reaction moments, an application specific moment limit for all pairing options for all rotor configurations for a commanded force magnitude/phase is achievable. The resulting force loading is that the nested rotors impart minimized moments on the structure to which they are attached, such as an aircraft structure. As FIGS. 3A and 3B illustrate, device reaction moments for CFG pairing is low, approaching, but not quite reaching, approximately zero (0).

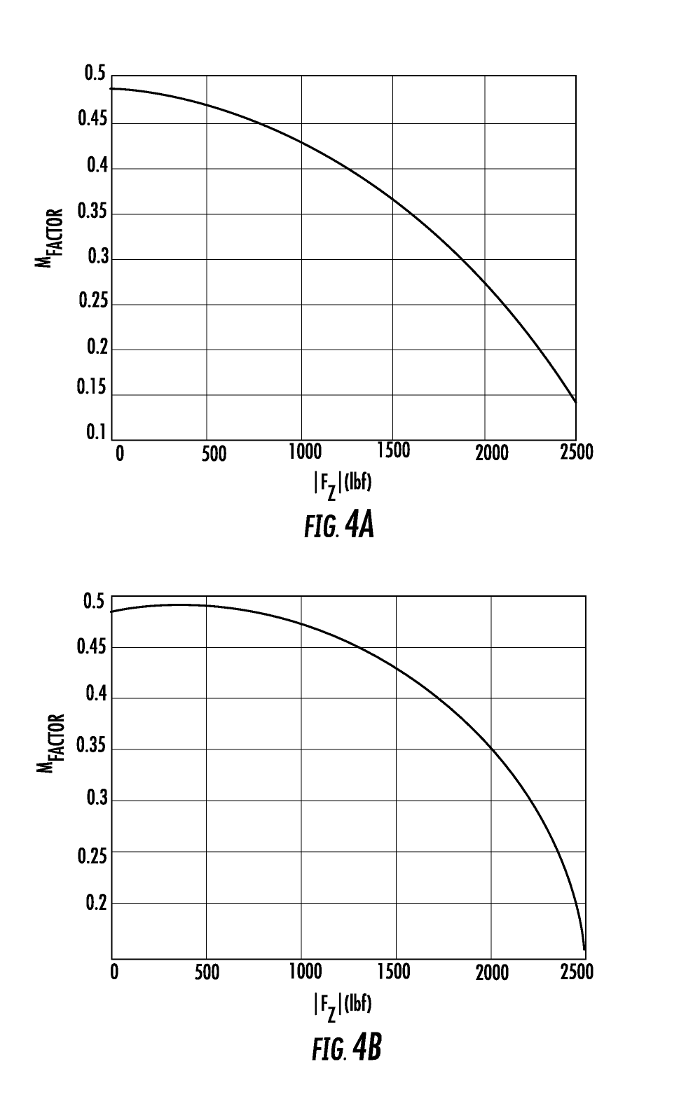

FIGS. 4A and 4B are moment limit plots illustrating the reduced reaction moments within device 10 where one rotor/side reverses direction and pairing becomes inner/inner and outer/outer. That is, the inner pair of masses and respective rotors spin in one direction and the outer pair of masses and respective rotors spin in the opposite direction. Protection against higher moments is provided by a simple monitor board that verifies spin direction. The simple monitor board consists of a single latching Hall sensor for each rotor.

FIG. 5 is a sectional view of a second embodiment of internal structures associated with a FG device, generally designated 50. Device 50 is similar in form and function to device 10; however, device 50 utilizes two (2) pair of nested inner and outer rotors per CFG. FG device 50 comprises back-to-back CFGs 12 and 14, each including nested inner and outer rotors. This embodiment is advantageous as a pair of bearings is configured to react the circular force from each rotor, which further improves the stiffness of device 50. The force plane of each rotor is nearly aligned with the CFG bearings, thereby splitting and/or reducing bearing loads as compared to cantilevered (e.g., unbalanced) rotors currently being used. This embodiment provides for at least a 20x improvement in the bearing life of device 50. The improved bearing life is achieved by constraining the CFG pairing with a low moment limit for any potential rotor configuration for the commanded force magnitude/phase.

In some aspects, each CFG 12 and 14 of device 50 includes a pair of nested inner and outer imbalance rotors, generally designated P_{A} and P_{B}. Each pair of nested rotors enables FG 50 to impart minimized moments to a vibrating structure, such as an aircraft structure. This allows bearing loads to remain low, and increases the MTBF of bearings to 50,000 hours or more. First CFG 12 includes a first pair of inner/outer imbalance rotors P_{A}. Second CFG 14 includes a second pair of inner/outer imbalance rotors P_{B}. First pair of imbalance rotors P_{A} of first CFG 12 includes a first imbalance rotor 52 disposed at least partially about a second imbalance rotor 54. Similarly, second pair of imbalance rotors P_{B} of second CFG 14 includes a first imbalance rotor 56 disposed at least partially about a second imbalance rotor 58. Outer rotors 52 and 56 are further away from a central shaft S than nested imbalance rotors 54 and 58.

Each pair of nested rotors P_{A} and P_{B} also include nested bearings. Each inner/outer rotor pair includes a first type or size of bearings B_{A} and a second type or size of bearings B_{B}. Nested bearings B_{B} are larger in size (e.g., diameter) than bearings B_{A}. Inner/outer bearings B_{A} and B_{B} may be provided in a side-by-side pair, which improves the stiffness of device 50. Nested bearings B_{B} are directly coupled and/or attached to shaft S. Because the bearings are provided in nested pairs (e.g., two nested bearings as compared to one nested bearing in FIG. 2), the bearings are able to react the force loading from both of the nested inner/outer rotors, and reduce bearing loads. Device 50 has a low reaction moment limit for any potential rotor configuration for any given commanded force magnitude/phase. This also provides for greater reliability with the MTBF of the rotor bearings being greater than or approximately 50,000 hours. This improved MTBF is a direct result of the low bearing loads from the nested rotors (e.g., pairs P_{A} and P_{B}).

Device 50 includes at least four drive motors D_{A} to D_{D} for rotating rotors and respective imbalance masses about shaft S. In some aspects, rotors 52, 54, 56, and 58 include respective rotor frames 52A, 54A, 56A, and 58A. Rotor frames 52A, 54A, 56A, and 58A support and/or couple with imbalance masses. In some aspects, one rotor 52 is configured to rotate a first imbalance mass M_{A}, one rotor 56 is configured to rotate a second mass M_{B}, one rotor 54 is configured to rotate a third imbalance mass M_{C}, and another rotor 58 is configured to rotate a fourth imbalance mass M_{D}. Any two rotors may be paired, such that any two imbalance masses are paired to rotate about shaft S in a same direction at a same time. Device 50 includes at least two side-by-side imbalance masses (i.e., M_{C} and M_{D}) nested within at least two other side-by-side imbalance masses (i.e., M_{A} and M_{B}).

As FIG. 5 illustrates, ends E of shaft S are fixedly held within device 50. A center plate 60 (e.g., extending from mounting plate 20) is provided between the inner motors D_{B} and D_{C}, and respective rotors. Center plate 60 is disposed about a heat sink H_{S} for improving the thermal conduction path for inner motors and bearings, thereby further improving reliability of device 50. Wiring for inner motors may optionally be routed through center plate 60 rather than through the inner diameter of the shaft.

FG device 50 provides multiple load paths (e.g., via dual bearings) from the rotors to center plate 60. As illustrated, multiple (e.g., dual) load paths are provided between rotors and center plate 60. A dual load path requires multiple failure points for the imbalance masses to separate from the rotors. This multiple failure point requirement improves burst containment protection for device. In addition, the dual load path from the rotors to the center plate 60 significantly reduces shaft stresses. The lower stress in the shaft S reduces the criticality of the shaft and reduces wear at shaft/housing interface.

In some aspects, a load path associated with device 10 includes transferring the load from outer imbalance masses M_{A} to M_{D}, to respective rotors 52, 56, to bearings B_{A}, to nested rotors 54, 58, to nested bearings B_{B}, to shaft S, to housings 16 and 18, to mounting plate 20, and to the vibrating structure. To further improve bearing lifetime, bearings B_{B} may be press fit about shaft S. Bearings B_{A/B} and shaft S may also include a similar material, such as steel. Bearings (B_{A,B}), shaft S, and/or rotors 52 to 58 may be manufactured from similar materials having a similar coefficient of thermal expansion (CTE). This reduces failure modes due to expansion/contraction stresses in materials having different CTEs.

By using nested bearings in the FG devise 50, the force plane nearly aligns with a mid-plane between the nested pairs of bearings. Such alignment reduces or eliminates cantilever bearing loads. Similar to the first embodiment shown in FIG. 2, the pair of nested bearings B_{B} further react the inner and outer mass loads, such that inner/outer loads are reacted by more than one bearing. FG devices herein have a normalized moment limit ratio, with a roll moment/2400+yaw moment/6000 (instantaneous).

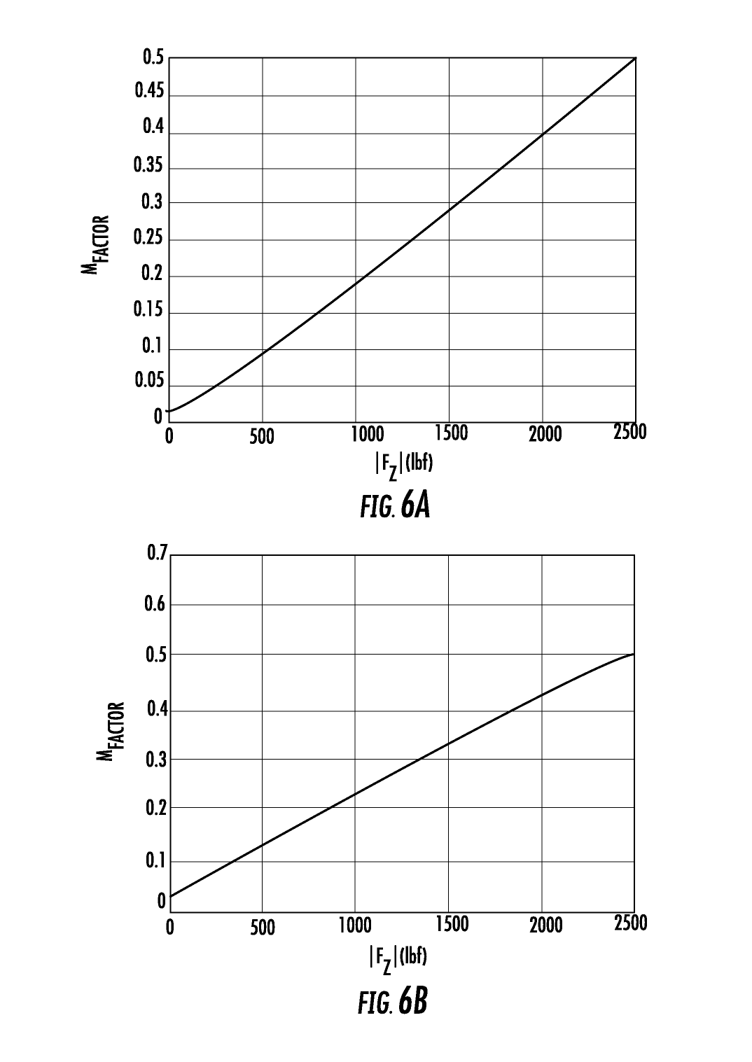

FIGS. 6A and 6B are moment limit plots illustrating normal operation of FG device 50, where the FG device 50 is not required to constrain force to phi transformation. By lowering the reaction moments, an application specific moment limit for all pairing options for all rotor configurations for a commanded force magnitude/phase is achievable. The resulting force loading is that the nested rotors impart minimized net reaction moments on the structure to which they are attached, such as an aircraft structure. As FIGS. 6A and 6B illustrate, device reaction moments for different pairing options is low, approaching but not quite reaching approximately zero (0).

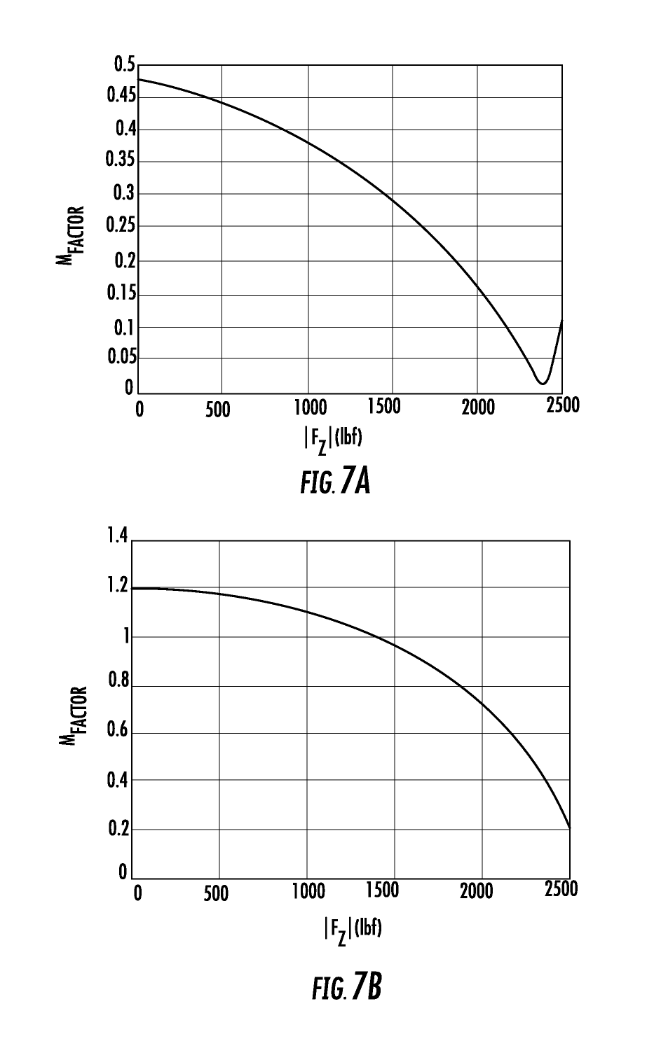

FIGS. 7A and 7B are moment limit plots illustrating the failure mode of device 50 where one (1) rotor/side reverses direction and pairing becomes inner/outer rotors. As FIG. 7B illustrates, protection against higher moments for this failure mode is provided by a simple monitor board that verifies spin direction. The simple monitor board consists of a single latching Hall sensor for each rotor.

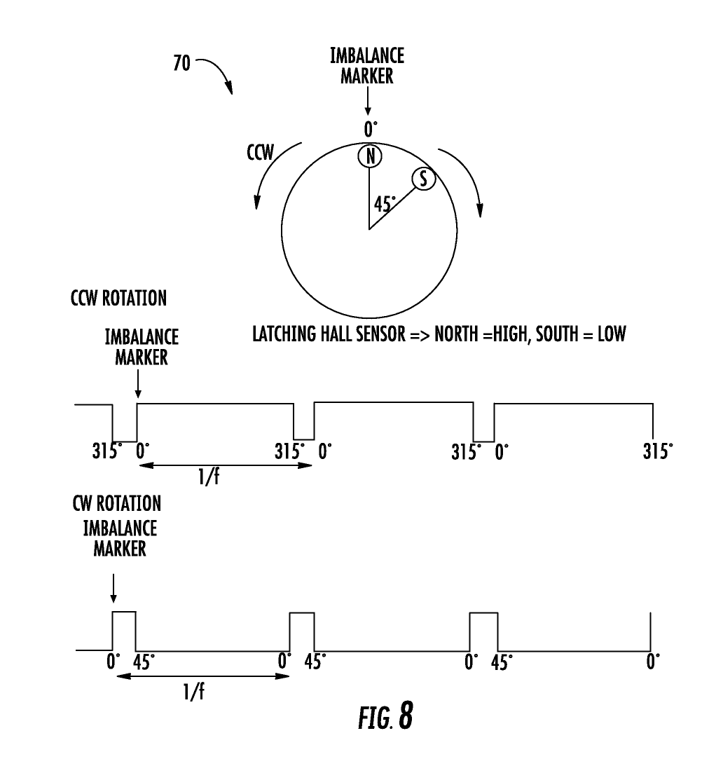

FIG. 8 illustrates third embodiment of an FG device, generally designated 70, which includes a simple monitor board used for checking spin direction. The rotation of the rotors is detected by determining if Hall state is predominately north or “high” or predominantly south or “low” on an imbalance marker. Over speed protection is provided by measuring time between rising edges. Rotor position for each rotor is estimated relative to a reference rotor having the imbalance marker, which would allow for the calculation of and thus protection against off axis forces and high roll moments. The phi for each rotor is estimated relative to a reference rotor. This allows calculation of, and thus protection against fore/aft forces and high roll moments.

FG devices and related methods described herein include a design utilizing two pair of nested rotors (e.g., FIG. 5, nested inner/outer rotors). FG devices and methods described herein may also include at least one pair of nested rotors, bearings, and imbalance masses in combination with at least one pair of side-by-side rotors, bearings, and imbalance masses as described in FIG. 2. At least one pair (e.g., any two of the four) of imbalance masses rotate in a same direction to minimize, cancel, and/or eliminate vibration within a structure, such as a rotary winged aircraft. FG devices and related methods described herein are advantageous as they require less power, have a longer bearing life, and manufactured at a lower cost.

While the present subject matter is described in reference to specific aspects, features, and illustrative embodiments, it will be appreciated that the utility of the subject matter herein is not thus limited, but rather extends to and encompasses numerous other variations, modifications and alternative embodiments, as will suggest themselves to those of ordinary skill in the field of the present subject matter, based on the disclosure herein. Various combinations and sub-combinations of the structures and features described herein are contemplated and will be apparent to a skilled person having knowledge of this disclosure. Any of the various features and elements as described herein may be combined with one or more other disclosed features and elements unless indicated to the contrary herein. Correspondingly, the subject matter herein as hereinafter claimed is intended to be broadly construed and interpreted, as including all such variations, modifications and alternative embodiments, within its scope and including equivalents of the claims.

What is claimed is:

1. A force generator (FG) device, the device comprising:
a housing;
a shaft centrally disposed within the housing;
at least two inner imbalance masses provided in a side-by-side configuration within the housing along the center shaft, the inner imbalance masses each supported by a large bearing movably coupled with the center shaft;
at least two outer imbalance masses oppositely positioned from each along the center shaft with one outer imbalance mass positioned outwardly from one of the inner imbalance masses and the other outer imbalance mass positioned outwardly from the other inner imbalance mass such that each inner imbalance mass is paired with the outer imbalance mass thereby forming a pair, wherein the outer imbalance masses each have a small bearing movably disposed about the center shaft; and
wherein the pairs of imbalance masses rotate about the center shaft to minimize moments imparted to a vibrating structure.

2. The FG device according to claim 1, wherein two back-to-back circular force generators (CFGs) are disposed within the housing.

3. The FG device according to claim 2, wherein each CFG includes a pair of nested rotors.

4. The FG device according to claim 3, wherein each pair of nested rotors are disposed proximate an outermost end of the shaft.

5. The FG device according to claim 1, wherein ends of the shaft are fixedly held within a portion of the housing.

6. The FG device according to claim 1, wherein a mean time between failures (MTBF) of the large bearing is approximately 50,000 hours or more.

7. The FG device according to claim 1, wherein a mean time between failures (MTBF) of the large bearing is approximately 60,000 hours or more.

8. The FG device according to claim 1, wherein the large and small bearings include steel or aluminum.

9. The FG device according to claim 1, wherein the device further comprises at least one Hall sensor disposed proximate the shaft.

10. The FG device according to claim 1, wherein the FG device generates a linear force.

11. The FG device according to claim 1, wherein the FG device generates a roll moment that is less than 2400 in-lb.

12. The FG device according to claim 1, wherein the FG device generates a yaw moment that is less than 6000 in-lb.

13. A helicopter comprising a device according to claim 1.

14. A force generator (FG) device, the device comprising:
a housing;
a shaft centrally disposed within the housing;
multiple imbalance rotors disposed within the housing and provided along the shaft, wherein:
at least two pairs of imbalance rotors in a nested configuration with respect to each other along the shaft;
the at least two pairs of imbalance rotors are supported in the nested configuration by large and small bearings; and
any two imbalance rotors are paired to rotate together in a same direction according to a desired vibration canceling force.

15. The FG device according to claim 14, wherein the multiple imbalance rotors include at least two pairs of nested imbalance rotors disposed in a side-by-side configuration along the shaft.

16. The FG device according to claim 14, wherein the two pairs of imbalance rotors are disposed at opposing ends of the shaft.

17. The FG device according to claim 14, wherein the two pairs of imbalance rotors are disposed at a central portion of the shaft.

18. The FG device according to claim 14, further comprising multiple imbalance masses supported by the multiple rotors.

19. The FG device according to claim 18, wherein at least two of the multiple imbalance masses are in a side-by-side configuration.

20. The FG device according to claim 19, wherein at least two other of the multiple imbalance masses are in a nested configuration.

21. The FG device according to claim 14, wherein the shaft and the large and small bearings comprise a same material.

22. The FG device according to claim 14, wherein a mean time between failures (MTBF) of the large bearings is approximately 50,000 hours or more.

23. The FG device according to claim 22, wherein a mean time between failures (MTBF) of the large bearings is approximately 60,000 hours or more.

24. The FG device according to claim 14, wherein the device further comprises at least one Hall sensor disposed proximate the shaft.

25. The FG device according to claim 14, wherein the device is encoderless.

26. The FG device according to claim 14, wherein multiple drive motors are configured for rotating the multiple imbalance rotors about the shaft.

27. The FG device according to claim 14, wherein the FG device generates a linear force.

28. The FG device according to claim 14, wherein the FG device generates a roll moment that is less than 2400 in-lb.

29. The FG device according to claim 14, wherein the FG device generates a yaw moment that is less than 6000 in-lb.

30. A helicopter comprising a device according to claim 14.

31. A method of controlling vibration within an aircraft, the method comprising:
detecting vibration within the aircraft;
receiving a force command at a force generator (FG) device, wherein the force generator comprises:
a housing;
a shaft centrally disposed within the housing;
multiple imbalance rotors disposed within the housing and provided along the shaft, wherein:
at least two pairs of imbalance rotors in a nested configuration with respect to each other along the shaft; and
the at least two pairs of imbalance rotors are supported by large and small bearings in the nested configuration;
pairing any two imbalance masses together and rotating a pair of imbalance masses via the rotors together in a same direction to cancel the detected vibration.

32. The method according to claim 31, wherein each pair of imbalance rotors is disposed on outermost ends of a shaft.

33. The method according to claim 31, wherein detecting vibration within the aircraft comprises measuring the vibration with a plurality of accelerometers.

34. The method according to claim 31, wherein rotating any two imbalance masses is controlled by a processor and multiple drive motors.

35. The method according to claim 31, further comprising generating a linear force.

36. The method according to claim 31, further comprising generating a roll moment that is less than 2400 in-lb.

37. The method according to claim 31, further comprising generating a yaw moment that is less than 6000 in-lb.

38. The method according to claim 31, wherein the FG device is operable for approximately 50,000 hours or more.

39. The method according to claim 31, wherein the FG device is operable for approximately 60,000 hours or more.
